(19) United States
(12) Patent Application Publication
(10) Pub. No.: US 2009/0136716 A1
(43) Pub. Date: May 28, 2009

(54) Profile arrangement and method for the manufacture of a profile arrangement

(76) Inventors: Marc Scherraus, Ulm (DE); Guido Schurr, Huettisheim (DE)

Correspondence Address: FLYNN THIEL BOUTELL & TANIS, P.C., 2026 RAMBLING ROAD, KALAMAZOO, MI, 49008-1631, US

(21) Appl. No.: 12/287,693

(22) Filed: Oct. 10, 2008

(30) Foreign Application Priority Data
Oct. 10, 2007 (DE) 10 2007 050 352.2

(51) Int. Cl. B32B 3/00; B29C 47/58

(52) U.S. Cl. 428/156; 264/101

(57) ABSTRACT

A profile arrangement and a method of manufacturing the same. The profile arrangement has a support part in the form of a plastic injection molding and an at least sectorwise, elastically flexible switching strip profile which has a holding portion which is at least sectorwise integrally joined to the support part by molding on a support part.

The invention relates to a profile arrangement with a support part in the form of a plastic moulding and an at least sectorwise, elastically flexible switching strip profile, said switching strip profile having a holding portion connected to the support part. The invention also relates to a method for the manufacture of a profile arrangement having a support part in the form of a plastic moulding and an at least sectorwise, elastically flexible switching strip profile.

DE 10349 650 A1 discloses a profile arrangement in which an elastically flexible switching or control profile has a holding portion drawn into a slot in a support part. The switching profile with the holding part is extruded, whereas the support part is in the form of an injection moulding. The slot has in the vicinity of its opening alternating projections and recesses, said projections forming an undercut behind which engages the holding portion of the switching profile.

It is also known to bond the holding portion of switching strip profiles to support parts, e.g. in that the holding portion is provided with an adhesive coating. To ensure a secure hold of the switching strip profile on the support part, comparatively time consuming material preparations are needed, e.g. the degreasing of the support part.

The invention aims at providing a profile arrangement manufacturable in a shorter time and in a more reliable manner from the process standpoint, together with a corresponding method for the manufacture of a profile arrangement.

According to the invention, for this purpose a profile arrangement is equipped with a support part in the form of a plastic moulding and an at least sectorwise, elastically flexible switching or control strip profile, the latter having a holding portion connected to the support part and where the holding portion of the switching strip profile is at least sectorwise integrally joined to the support part by moulding on a support part portion.

Due to the fact that the holding portion of the switching strip profile is joined to the support part by moulding on, secure fastening is obtained and the integral joint between support part and holding portion of the switching strip profile is formed during the injection moulding process of said support part. The joining of the switching strip profile and support part takes place in a single manufacturing step, which is in any case needed for manufacturing the support part. This facilitates manufacture, because there is no need with respect to said support part to carry out any preparatory work, e.g. degreasing or the like, such as occurs when the switching strip profile is bonded on. In addition, this makes possible very tight manufacturing tolerances, because the switching strip profile is always positioned in the same location relative to the support part and specifically no positioning errors can arise on placing the switching strip profile on the support part.

According to a further development of the invention the support part portion has at least one rib and the holding portion of the switching strip profile is integrally joined to a narrow side of the rib.

Ribs on the support part portion ensure a stabilization of the support part. However, as the holding portion of the switching strip profile is connected to a narrow side of the rib, during the injection moulding process less pressure has to be exerted on the switching strip profile than would be the case with full-surface contacting of the holding portion of the switching strip profile. This makes it possible to ensure that during the moulding on of the support part portion, the switching strip profile is only slightly deformed and also in the end state has an optimum cross-section for fulfilling the switching strip function.

According to a further development of the invention the support part has several ribs, which with the end portion thereof in each case project freely from a base portion of the support part, the holding portion of the switching strip profile resting on the end portions of the rib and is integrally joined thereto.

This brings about a very tight connection between support part and switching strip profile, because even in the case of a limited material thickness the ribs can well withstand bending forces acting perpendicular to their narrow sides. In addition, the pressure exerted on the holding portion of the switching strip profile and which comes into effect on injection moulding the support part, only has an effect in very small surface areas of the holding portion of the switching strip profile, because it only rests on the end portions of the ribs and consequently on a free narrow side of each rib. Thus, deformations of the switching strip profile by the pressure exerted during injection moulding can be largely avoided.

Alternatively the holding portion can have a strip or rib extending away from the switching strip profile and which following the moulding on of the support part is surrounded on both sides by the plastics material of the support part. As a result of such a design the injection moulding pressure during the injection moulding of the support part exclusively acts on the strip or rib of the holding portion of the switching strip profile, because injection moulding takes place on the latter from two opposite sides. The elastically flexible portion of the switching strip profile which assumes the actual switching function, can be so placed on the part of the holding portion not subject to the action that during the injection moulding of the support part it is not exposed to the injection moulding pressure and consequently cannot become permanently deformed.

In a further development of the invention the holding portion of the switching strip profile is provided with projections, ribs and/or steps.

This makes it possible to increase the contact surface between support part and holding portion of the switching strip profile, which improves the integral joining action.

In a further development of the invention the holding portion of the switching strip profile is provided with at least one undercut and is integrally joined to the support part in the vicinity of the undercut.

If in addition to the integral joining action there is a positive engagement between support part and holding portion of the switching strip profile, the connection between said switching strip profile and said support part can be made even more reliable. The holding portion e.g. has a cross-sectionally dovetailed, projecting strip, which is surrounded by the plastics material of the support part on moulding on the latter. Thus, apart from the integral joining action, there is a positive engagement. Alternatively or additionally it is possible to provide dovetailed slots on the holding portion which are filled by the plastics material of the support part.

In a further development of the invention the support part is constructed as an elongated strip and provided with fixing means for fixing to a vehicle body.

As a result a switching strip profile can be manufactured together with the support part as an element to be directly fitted to the car and for fixing the support part it is e.g. possible to provide expansion rivets or the like.

In a further development of the invention the switching strip profile is curved along its longitudinal direction and/or along its transverse direction.

Thus, the switching strip profile can adapt to curvatures of door or lid openings on the car. It is essential that during the moulding on of the support part the switching strip profile is fixed in its curved position. Even in the case of spatially curved paths of a switching strip profile, it is possible to ensure that the said profile is always joined to the support part in the predetermined position. Thus, with limited costs highly accurately fitting parts can be manufactured.

In a further development of the invention the holding part of the switching strip profile is at least sectorwise made from electrically conductive material. Thus, the holding part of the switching strip profile can be used as a shield electrode during the capacitive detection of obstacles.

In a further development of the invention the support part is at least sectorwise made from electrically conductive material.

Alternatively or additionally to the holding portion, in this way the support part can be used for shielding an electric field, which emanates from the switching strip profile in operation for the capacitive detection of obstacles. As the support part is intended for fitting to a car body, an electrical field for the detection of obstacles must extend away from the body. This does not generally cause a problem in the case of sheet metal bodies, but if e.g. plastic doors or lids are used, a support part made from electrically conductive material significantly facilitates the shielding of such an electrical field.

In a further development of the invention the switching strip profile has at least two conductors which are spaced from one another and run parallel to the longitudinal direction of the switching strip profile, a first conductor being constructed as a capacitor electrode for generating an electrical field and a second conductor as a shield electrode for influencing the electrical field. The first and second conductors or also further conductors of the switching strip profile can advantageously be electrically contacted with one another during the deformation of the switching strip profile. This provides a tactile detection in addition to the contactless, capacitive detection of obstacles. On the side of the first conductor essentially facing the second conductor it is possible to provide in spaced manner with respect to said first conductor at least one third conductor located within the switching strip profile. Such a third conductor can be used for diagnostic purposes or also for influencing the electrical field emanating from the first conductor. In the case of a third conductor provided for diagnostic purposes it is e.g. possible to establish by means of the third conductor whether an electrical field emanates from the first conductor and whether the capacitive sensor is still functional. In the case of the influencing of the electrical field the third conductor can e.g. be placed on earth or ground potential so as to influence the electrical field from the first conductor. Finally, the third conductor can be at the same potential as the first conductor in order to enlarge the sensor surface. It is obviously possible to combine with one another the aforementioned functions of the third conductor, in that switching means are provided so as to make it possible to use the third conductor for different functions. Considered in the longitudinal direction of the switching strip profile various functions of the third conductor can also be implemented spatially in order to satisfy spatial considerations in the opening area of a vehicle door or lid.

The problem of the invention is also solved by a method for the manufacture of a profile arrangement with a support part in the form of a plastic moulding and an at least sectorwise, elastically flexible switching strip profile, in which the following steps are provided:
placing the switching strip profile in a plastic injection mould, so that a holding portion of the switching strip profile is at least sectorwise accessible from a cavity of said plastic mould,
injection moulding the support part, the plastic in the flowable state used for the moulding of the support part at least sectorwise contacting the holding portion of the switching strip profile and
removing the support part with the moulded on switching strip profile.

The inventive method ensures that the switching strip profile is always fixed on the support part in the precisely predetermined position. This takes place by simply inserting the switching strip profile in a plastic injection mould and then moulding the support part. Following the removal of the support part with the moulded on switching strip profile, a substantially ready to install component is obtained.

In a further development of the invention the switching strip profile is placed in a matching slot of a plastic mould and a vacuum is applied to the slot to suck on the switching strip profile.

In this way the switching strip profile can be fixed in the plastic injection mould. This is particularly important if the switching strip profile in the plastic mould is to assume a curved and optionally even spatially curved shape.

Switching strip profiles are extruded and consequently initially have a straight or linear shape. Thus, if switching strip profiles are to be given a curved shape, there are necessarily certain springback forces. The application of a vacuum to a slot in the plastic mould can reliably prevent a springing back of the switching strip profile. Following the moulding of the support part, the switching strip profile is integrally joined to said support part and is therefore reliably held in the predefined shape.

Further features and advantages of the invention can be gathered from the claims and the following description of preferred embodiments of the invention. Individual features of the different embodiments can be combined in a random manner without passing beyond the scope of the invention. In the drawings show:

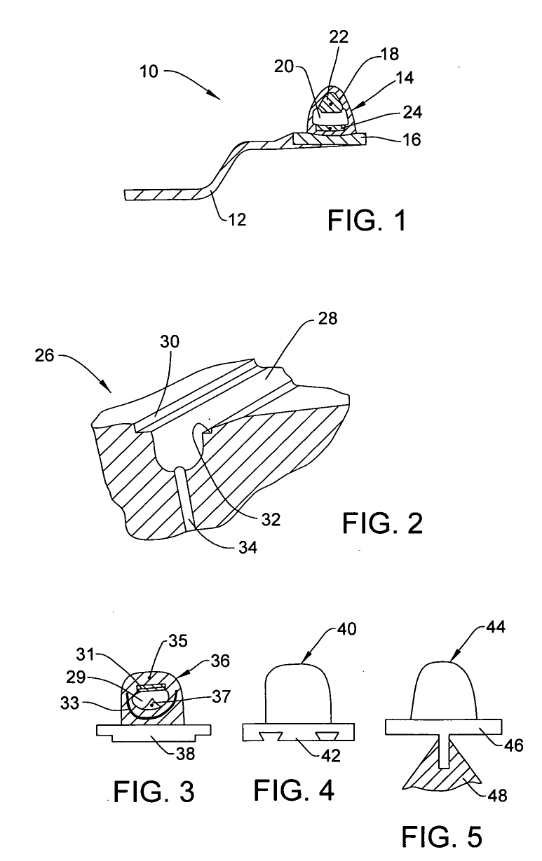

FIG. 1A sectional view of an inventive profile arrangement in a first embodiment.

FIG. 2 A sectorwise sectional view of an injection mould for manufacturing the inventive profile arrangement of FIG. 1.

FIG. 3 A diagrammatic sectional view of a switching strip profile according to a second embodiment of the invention.

FIG. 4 A diagrammatic view of a switching strip profile according to a third embodiment of the invention.

FIG. 5 A diagrammatic sectional view of a switching strip profile according to a fourth embodiment of the invention.

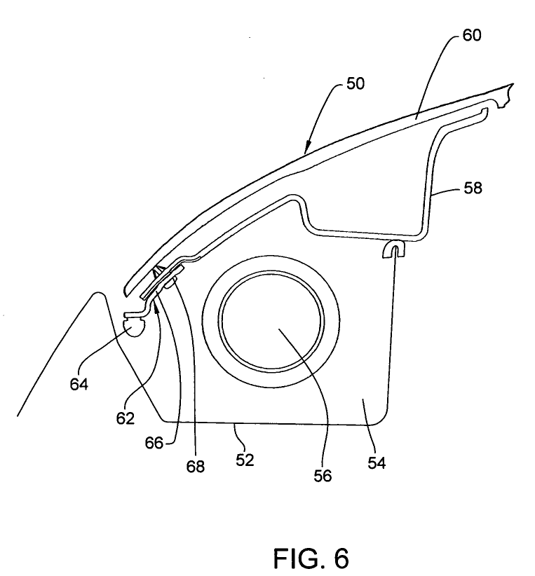

FIG. 6 A sectorwise sectional view of a car in the vicinity of the tailgate with an inventive profile arrangement according to a fifth embodiment of the invention.

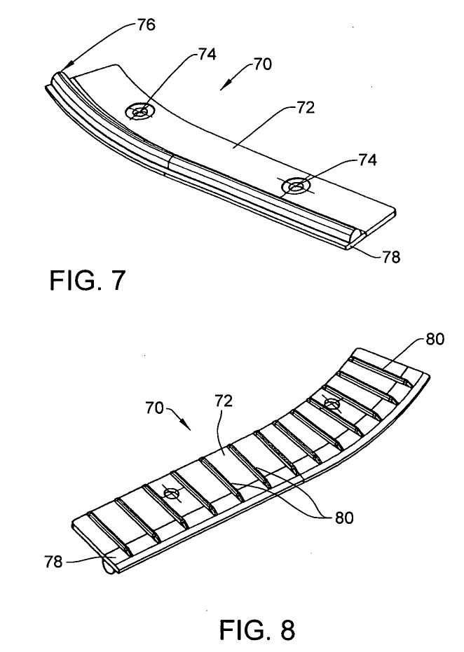

FIG. 7 A perspective view from above of an inventive profile arrangement according to a sixth embodiment of the invention.

FIG. 8 The profile arrangement of FIG. 7 obliquely from below.

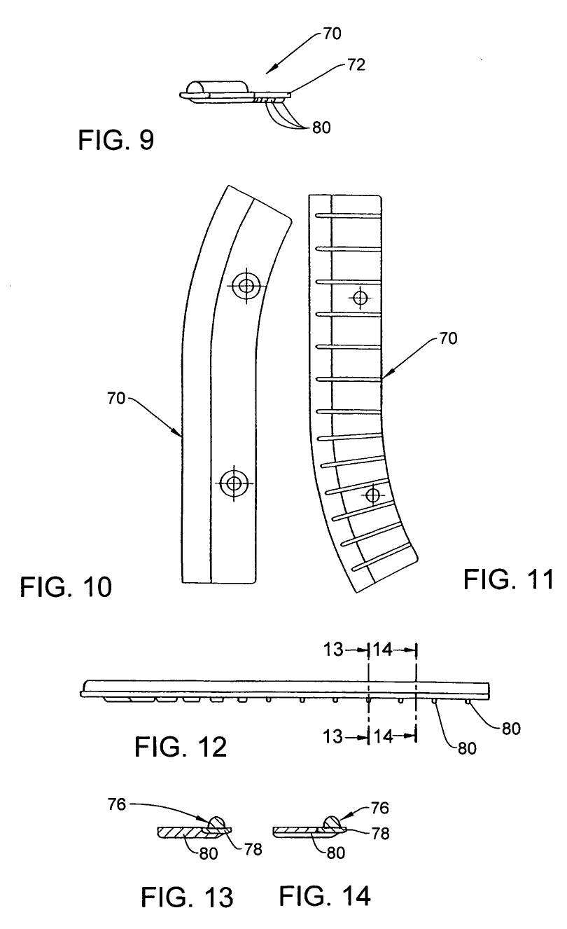

FIG. 9 The profile arrangement of FIG. 7 in a view from the front.

FIG. 10 The profile arrangement of FIG. 9 in a view from above.

FIG. 11 The profile arrangement of FIG. 9 from below.

FIG. 12 A side view of the profile arrangement of FIG. 9.

FIG. 13 A view on the sectional plane A-A of FIG. 12.

FIG. 14 A view on the sectional plane B-B of FIG. 12.

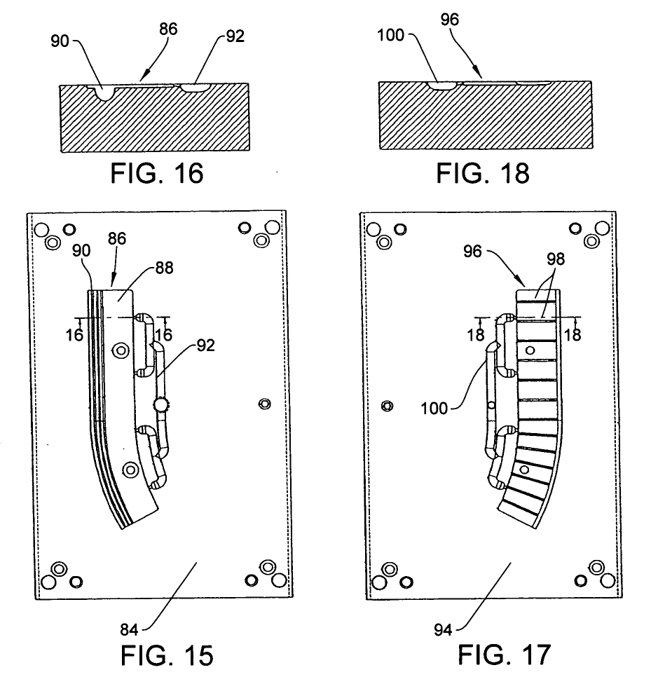

FIG. 15 A plan view of the top of an injection mould for the manufacture of the inventive profile arrangement according to FIG. 7.

FIG. 16 A view on sectional plane A-A of FIG. 15.

FIG. 17 A plan view of the lower part of an injection mould for manufacturing the inventive profile arrangement of FIG. 7.

FIG. 18 A view on sectional plane B-B of FIG. 17.

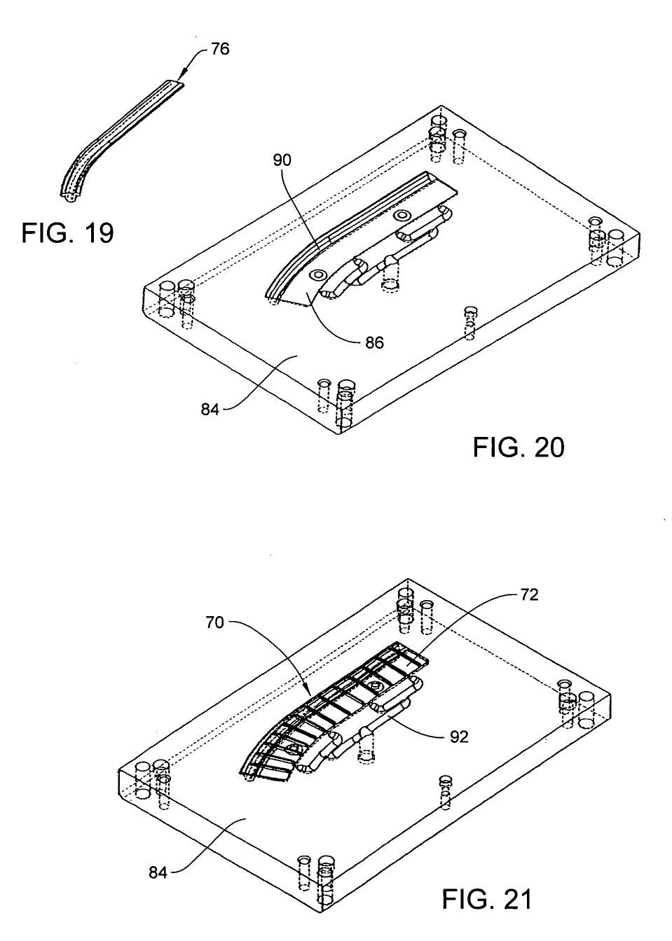

FIG. 19 A perspective view of the switching strip profile prior to insertion in a mould.

FIG. 20 The upper part of the injection mould of FIG. 15 prior to the insertion of the switching strip profile according to FIG. 19.

FIG. 21 The upper part of the injection mould of FIG. 20 with the completed profile arrangement located therein.

FIG. 1 shows an inventive profile arrangement 10 according to a first embodiment with a support part 12 and a switching strip profile 14. Switching strip profile 14 has a holding portion 16, which is implemented in the form of a strip with an approximately rectangular cross-section. On the holding portion 16 is placed the actual switching profile 18, which is made from elastically flexible plastic and has a tubular shape. Switching profile 18 has a cavity 20 to which are adjacent on facing sides a first conductor 22 and a second conductor 24. Both of the conductors 22 and 24 are made from a conductive plastic and roughly in the centre of each conductor 22, 24 is located a strand wire. If the switching strip 18 is compressed, e.g. if said strip is pressed against a human hand, conductors 22, 24 come into electrical contact, so that a switching signal can be generated, which is in turn used for reversing a drive motor, e.g. to reopen a sliding door to the leading edge of which is fixed profile arrangement 10. Switching strip profile 14 is manufactured by extrusion.

The switching strip profile 14 is constructed as a so-called tactile switching strip and is able to detect obstacles if they come into contact with said switching strip 18. Alternatively or additionally the switching strip 18 can be constructed as a contactless sensor, where obstacles are detected capacitively and in contactless manner by means of an electrical field. In this case from the first conductor 22 emanates an electrical field and the second conductor 24 is grounded or earthed in order to orient the electrical field in the detection direction. The change to the electrical field as a result of an obstacle can then be detected by means of a suitable evaluation electronics.

The left-hand narrow side and underside of the holding portion 16 in FIG. 1 is adjacent to the support part 12. In the contact area with support part 12 holding portion 16 and support part 12 are integrally joined. This integral joint is obtained in that the switching strip profile 14 is placed in an injection mould and then the support part 12 is injection moulded in said mould. The flowable plastic introduced into the mould is integrally joined in the vicinity of the contact surface with the material of holding portion 16. Thus, when choosing the materials for support part 12 and holding portion 16 it must be ensured that the materials chosen are joined together during the injection moulding process. For example, the material for support part 12 and that for holding portion 16 can be chosen from the group of polyolefins.

FIG. 2 shows a portion of an injection mould, such as can be used for manufacturing the inventive profile arrangement 10. Mould 26 has a slot 28 in which the switching strip profile 14 can be inserted. As is clear, switching strip profile 14 with holding portion 16 at the top is introduced into slot 28 until the holding portion 16 is located in accurately fitting manner in recesses 30, 32, which are laterally adjacent to the slot 28. After placing the switching strip profile 14 in slot 28, a vacuum is applied to a hole 34, which is connected to the bottom of slot 28, so that the profile 14 is reliably held in slot 28. Considered over the length of slot 28 several holes 34 can be provided. After closing mould 26 plastic is injected and consequently support part 12 is moulded onto the holding portion 16 of switching strip profile 14. Moulding on takes place in the embodiment shown in such a way that the holding portion 16 is undermoulded in full-surface manner with the plastics material of support part 12 and also sectorwise undermoulded on its lateral edge to the left in FIG. 1. Following the setting of the plastic for support part 12, the complete profile arrangement 10 can be removed from injection mould 26.

FIG. 3 diagrammatically shows a switching strip profile 36 according to a second embodiment of the invention. A holding portion 38 is provided in this case with a shoulder in the vicinity of both its right and left-hand lateral edges. This makes it possible to enlarge a contact surface with the plastics material of the support part and the integral joining effect can be improved. Switching strip profile 36 is extruded together with holding portion 38, so that the shoulders on the right and left-hand sides of holding portion 38 run through in the longitudinal direction.

The switching strip profile 36 is designed both for a capacitive, contactless detection of obstacles and also for a tactile detection of obstacles. In the vicinity of its flexible plastic material switching strip, the switching strip profile 36 has a cavity 29 and adjacent to the latter a first conductor 31 with a rectangular cross-section. In the plastic of the switching strip, outside cavity 29 is provided a cross-sectionally U-shaped, second conductor 33. On the side of the first conductor 31 facing the second conductor 33 is provided a third conductor 35, which merely comprises strand wires. Finally, adjacent to the cavity 29 on the side thereof facing the first conductor 31 is provided a fourth conductor 37. All the conductors of the switching strip profile 36 are only diagrammatically represented in FIG. 3. With the exception of the third conductor 35 all the conductors 31, 33 and 37 are made from a conductive polymer area in whose centre is located a strand wire. The strand wires can be incorporated during extrusion.

For a capacitive detection of obstacles the first conductor 31 is used as a capacitor electrode from which emanates an electrical field. Towards the back of the first conductor 31 the electrical field is shielded by the U-shaped, second conductor 33, which is earthed or grounded. If an obstacle enters the electrical field emanating from the first conductor 31, it can be detected by suitable evaluation electronics and a switching signal can be generated. To improve the shielding of the electrical field from the first conductor, the holding portion 38 can also be made from conductive plastics material and grounded or earthed.

The third conductor 35 can be used for different purposes. It can firstly be used as a test electrode to establish whether an electrical field emanates from the first conductor 31 and consequently the capacitive sensor is ready to operate. Alternatively the third conductor 35 can be placed on the same electrical potential as the first conductor 31 and consequently contributes to an enlargement of the sensor surface. Finally, the third conductor 35 can be grounded or earthed, in order to optionally influence the electrical field from the first conductor 31.

For operation as a tactile switching strip which can simultaneously take place for capacitive operation, a resistance between the first conductor 31 and the fourth conductor 37 is detected. If the switching strip of the switching strip profile 36 is compressed by an obstacle, the first conductor 31 comes into contact with the fourth conductor 37, so that a short-circuit occurs between the two conductors 31, 37 and this is detected and used for generating a switching signal.

FIG. 4 diagrammatically shows a further switching strip profile 40. A holding portion 42 of said profile 40 is provided on its underside with two slots, which cross-sectionally have a dovetail shape. On moulding on the support part, liquid plastic penetrates said slots and following the setting of the plastic in addition to the integral joint between holding portion 42 and the support part a positive engagement takes place. For bringing about a positive engagement it is obviously possible to form in addition to the dovetailed slots, dovetailed projections or strips on a holding portion.

FIG. 5 diagrammatically shows a switching strip profile 44 according to a fourth embodiment of the invention. A holding portion 46 of switching strip profile 44 is centrally provided with a rib projecting from its underside. On moulding on a support part 48 the plastic solely contacts said rib, but not the remaining parts of holding portion 46. For this purpose the support part 48 has a cross-sectionally triangular configuration in whose tip is embedded the rib. In this way the pressure exerted during the injection moulding of support part 48 acts bilaterally on the rib of holding portion 46. The pressure exerted on the rib is cancelled out through the chosen configuration and can in particular not lead to a deformation of the holding portion 46 in areas outside the rib. Specifically the actual switching strip of switching strip profile 44 cannot be permanently deformed during an injection moulding process.

FIG. 6 is a sectorwise sectional view of a car in the vicinity of its tailgate 50. A car body 52 forms in the marginal area of tailgate 50 a water channel 54 in which is located an electrical spindle drive 56 for opening and closing tailgate 50. Tailgate 50 has a sheet metal structure 58 on which is located a tail disk 60. In the area between body 52 and tailgate 50 there is a risk of persons or objects being jammed during the closure of said tailgate 50. Thus, a lateral edge of tailgate 50 is equipped with an inventive profile arrangement 62. The inventive profile arrangement 62 comprises a switching strip profile 64 joined to a support part 66 and which is in turn joined by plastic expansion rivets 68 to the sheet metal structure 58 of tailgate 50. In the opened state of the tailgate 50, switching strip profile 64 forms that part of the border of said tailgate 50 which must first contact an obstacle on closing the tailgate 50. On contact with the switching strip profile 64 a switching signal can then be generated, which reverses the electrical spindle drive 56 and reopens tailgate 50. Alternatively or additionally the switching strip profile 64 can be designed for the contactless, capacitive detection of obstacles. If an obstacle is detected in the gap between tailgate 50 and body 52, the electrical spindle drive 56 can be stopped or reversed.

The switching strip profile 64 is fixed to a cross-sectionally approximately L-like portion of support part 66 projecting from the sheet metal structure 58. On contact with an obstacle said L-like portion of support part 66 can be additionally deformed in order to ensure a certain give on contact with an obstacle.

In the case of capacitive detection of obstacles, an electrical field emanates from the switching strip profile 64 and said field is modified by the penetration of an obstacle into the gap between tailgate 50 and body 52. This change to the electrical field is then detected. To influence the electrical field from switching strip profile 64 and concentrate the same in the area of the gap between tailgate 50 and body 52, support part 66 can be made from electrically conducting plastic. The support part 66 is then electrically contacted with the tailgate sheet metal structure 58 in order to shield the electrical field from switching strip profile 64 towards tailgate 50. In the same way, the holding portion of switching strip profile 64 which is joined to the support part 66 can also be made from electrically conductive material.

FIG. 7 shows an inventive profile arrangement 70 according to a sixth embodiment of the invention. A support part 72 is provided with two through openings 74 through which can be introduced e.g. plastic expansion rivets in order to join the holding portion 72 to a vehicle door. A switching strip profile 76 is connected to holding part 72, which is moulded onto a holding portion 78 of switching strip profile 76. The resulting integral joint between holding portion 78 and support part 72 occurs between the longitudinal side, to the right in FIG. 7, of holding portion 78 and support part 72.

As can be gathered from FIG. 8, which shows from below the profile arrangement 70 of FIG. 7, in the area emanating from its longitudinal edge and which is in contact with support part 72, holding portion 78 is undermoulded over a certain distance, so that there is a flat, integral joint between a marginal area of the underside of holding portion 78 and support part 72.

The underside of support part 72 is also provided with several substantially parallel, mutually spaced ribs 80, which project from the base part of support part 72 and rest with their free, projecting portion on an underside of holding portion 78. Between an underside of holding portion 78 remote from the switching strip of switching strip profile 76 and the ribs 80, during the injection moulding of support part 72 this brings about an integral joint in the vicinity of a narrow side of ribs 80. Thus, the ribs 80 hold the switching strip profile 76 in the manner of cantilevered beams or girders. This significantly reduces a contact surface between support part 72 and holding portion 78 of switching strip profile 76 in a pressure-sensitive area, so that during the moulding of support part 72 there are no permanent deformations to the holding portion 78 and therefore the entire switching strip profile 76. Specifically a contact surface between support part 72 and holding portion 78 is reduced in the area where the compressive forces could compress the switching strip of switching strip profile 76 on injection moulding support part 72. In the area precisely facing the switching strip, on the holding portion 78 are only placed the projecting ends of ribs 80. Compressive forces on the holding portion 78 are much reduced in the direction of the switching strip as compared with the situation where the top underside of holding portion 78 in FIG. 8 was undermoulded in full-surface manner with plastic of support part 72.

FIG. 9 shows the profile arrangement 70 of FIG. 7 from the front, which clearly shows the ribs 80 of support part 72.

FIG. 10 shows the profile arrangement 70 of FIG. 9 from above and FIG. 11 shows the profile arrangement 70 of FIG. 9 from below. FIG. 12 shows the profile arrangement 70 of FIG. 9 from the side and it can be seen that the ribs 80 are all of the same height.

FIG. 13 is a view of sectional plane A-A of FIG. 12 and FIG. 14 shows a view of sectional plane B-B of FIG. 12. FIGS. 13 and 14 make clear the construction of the ribs 80, which carry the holding portions 78 of switching strip profile 76 in balcony-like manner. It is clear that the ribs 80 do not extend over the entire width of holding portion 78 and instead only extend to an area facing the lateral edge of the switching strip on the opposite side of holding portion 76. Forces acting on the switching strip of switching strip profile 76 can therefore be introduced over a short path into ribs 80 and distributed over support part 72.

FIG. 15 shows an upper part 84 of an injection mould for manufacturing the inventive profile arrangement. A cavity 86 of upper part 84 has a portion 88 for shaping the support part and a slot 90 for inserting the switching strip profile. Channels 92 are provided for supplying the flowable plastic during injection moulding.

FIG. 16 is a view on sectional plane A-A of FIG. 15. It is possible to see the slot 90 for inserting the switching strip profile and also the channels 92.

FIG. 17 shows a lower part 94 of an injection mould for manufacturing an inventive profile arrangement 70. A cavity 96 has depressions 98 for forming ribs 80 and also channels 100 for supplying plastics material.

FIG. 18 on sectional plane B-B of FIG. 17 illustrates the design of cavity 96, even though the recesses 98 for forming ribs 80 cannot be seen in FIG. 18.

FIG. 19 shows the switching strip profile 76 following the extrusion process and prior to placing in the injection mould.

FIG. 20 shows the upper part 84 of the mould, the switching strip profile 76 of FIG. 19 being placed in the slot 90.

FIG. 21 shows the upper part 84 after injecting the plastic for the support part 72 and after removing the lower part 94 of the mould shown in FIG. 17. The complete inventive profile arrangement 70 is now located in upper part 84 and can be completely removed therefrom. It is only necessary to remove from support part 72 the plastics material out of the channels 92. Otherwise, following removal from the mould, support part 72 is essentially a component which is ready to install and it is only necessary to contact electrically the strand wires in the conductors of the switching strip.

1. Profile arrangement with a support part (12; 66; 72) in the form of a plastic injection moulding and an at least sectorwise, elastically flexible switching strip profile (14; 64; 76), which has a holding portion (16; 38; 42; 46; 78) which is joined to the support part (12; 66; 72), characterized in that the holding portion (16; 38; 42; 46; 78) of the switching strip profile (16; 38; 42; 46; 78) is at least sectorwise integrally joined to the support part (12; 66; 72) by moulding on a support part portion.

2. Profile arrangement according to claim 1, characterized in that the support part portion has at least one rib (80) and the holding portion (78) of the switching strip profile (76) is integrally joined to a narrow side of rib (80).

3. Profile arrangement according to claim 2, characterized in that support part (72) has several ribs (80), which project with their end portion freely from a base portion of support part (72), the holding portion (78) of switching strip profile (76) resting on the end portions of ribs (80) and is integrally joined thereto.

4. Profile arrangement according to claim 1, characterized in that the holding portion (38; 42; 46) of switching strip profile (36; 40; 44) is provided with projections, slots, ribs and/or steps.

5. Profile arrangement according to claim 1, characterized in that the holding portion (42) of switching strip profile (40) is provided with at least one undercut and is positively joined to the support part in the vicinity of the undercut.

6. Profile arrangement according to claim 1, characterized in that the support part (66; 72) is constructed as an elongated strip and provided with fixing means (68) for fixing to a vehicle body (52).

7. Profile arrangement according to claim 1, characterized in that the switching strip profile (76) is curved along its longitudinal direction and/or along its transverse direction.

8. Profile arrangement according to claim 1, characterized in that the holding part of the switching strip profile is at least sectorwise made from electrically conductive material.

9. Profile arrangement according to claim 1, characterized in that the support part is made at least sectorwise from electrically conductive material.

10. Profile arrangement according to claim 1, characterized in that the switching strip profile (36) has at least two mutually spaced conductors (31; 33) running parallel to the longitudinal direction of the switching strip profile (36), a first conductor (31) being constructed as a capacitor electrode for generating an electrical field and a second conductor (33) as a shield electrode for influencing the electrical field.

11. Profile arrangement according to claim 10, characterized in that the conductors (31, 37) of the switching strip profile (36) come into electrical contact on deforming the switching strip profile.

12. Profile arrangement according to claim 10, characterized in that at least one third conductor (35) is provided within the switching strip profile (36) on a side of the first conductor (31) and spaced therefrom which substantially faces the second conductor (33).

13. Method for the manufacture of a profile arrangement with a support part in the form of a plastic moulding and an at least sectorwise, elastically flexible switching strip profile, characterized by the following steps:
inserting the switching strip profile in a plastic injection mould, so that a holding portion of the switching strip profile is at least sectorwise accessible from a cavity of the plastic mould,
moulding the support part, the plastic used for moulding the support part at least sectorwise contacting in the flowable state the holding portion of the switching strip profile and
removing the support part with the moulded on switching strip profile.

14. Method according to claim 13, further characterized by the insertion of the switching strip profile in a matching slot of a plastic injection mould and applying a vacuum to the slot for sucking on the switching strip profile.
